(19) United States
(12) Patent Application Publication
(10) Pub. No.: US 2023/0056570 A1
(43) Pub. Date: Feb. 23, 2023

(54) DEVICE AND METHOD FOR ASSESSING LEARNING ABILITY OF USER

(71) Applicant: RIIID INC., Seoul (KR)

(72) Inventor: Hyun Bin LOH, Seoul (KR)

(73) Assignee: RIIID INC., Seoul (KR)

(21) Appl. No.: 17/890,612

(22) Filed: Aug. 18, 2022

(30) Foreign Application Priority Data
Aug. 20, 2021 (KR) 10-2021-0109927
Jun. 2, 2022 (KR) 10-2022-0067538

(51) Int. Cl. G09B 7/00; G06N 3/063

(52) U.S. Cl. CPC G09B 7/00; G06N 3/063

(57) ABSTRACT

Provided are a device and method for assessing a user's learning ability. The method includes acquiring target assessment data of a target user and a reference user related to a target domain, wherein the target assessment data includes question data related to the target domain and answer data of each of the target user and the reference user for the question data, acquiring a target neural network model of which training has been completed, acquiring comparison information representing the target user's ability in relation to the reference user's ability in the target domain through the target neural network model, and calculating the target user's virtual score in the target domain on the basis of the comparison information.

### CROSS-REFERENCE TO RELATED APPLICATION

This application claims priority to and the benefit of Korean Patent Application No. 10-2021-0109927, filed on Aug. 20, 2021, and Korean Patent Application No. 10-2022-0067538, filed on Jun. 2, 2022 the disclosure of which is incorporated herein by reference in its entirety.

### BACKGROUND

### 1. Field of the Invention

The present invention relates to a method, device, and system for assessing a learning ability. Specifically, the present invention relates to a learning ability assessment method, device, and system for quantifying a learner's learning ability in a new domain in which assessment data is not enough.

### 2. Discussion of Related Art

With the development of artificial intelligence technology, an educational technology for diagnosing a learner's ability and recommending educational content on the basis of the diagnosis result is attracting attention. In particular, since a technology for providing optimal educational content according to learners' abilities is required, there is an increasing demand for a technology for precisely quantifying a learner's ability.

Up until now, research has been performed on technologies for assessing a learner's ability using the learner's answer to a question and the like. For example, according to the related art, a neural network model is trained with learners' learning data and the learners' actual score information such that a leaner's ability is quantified. However, training a neural network model requires a considerable amount of learning data of learners and the learners' actual score information. Accordingly, the related art has a problem in that it takes a considerable amount of cost and time to collect a training set for training a neural network model.

Therefore, it is necessary to develop a learning ability assessment method, device, and system for precisely quantifying a learner's learning ability in a situation where there are not enough training sets for training a neural network model.

### SUMMARY OF THE INVENTION

The present invention is directed to providing a learning ability assessment method, device, and system for quantifying a learner's ability.

The present invention is also directed to providing a learning ability assessment method, device, and system for quantifying a learner's ability in an educational domain in which assessment data is not enough.

Objects of the present invention are not limited to that described above, and other objects which have not been described above will be clearly understood by those of ordinary skill in the art from the specification and the accompanying drawings.

According to an aspect of the present invention, there is provided a method of assessing a learning ability, the method including acquiring target assessment data of a target user and a reference user related to a target domain, wherein the target assessment data includes question data related to the target domain and answer data of the target user and the reference user for the question data, acquiring a target neural network model of which training has been completed, acquiring comparison information representing the target user's ability in relation to the reference user's ability in the target domain through the target neural network model, and calculating the target user's virtual score in the target domain on the basis of the comparison information.

According to another aspect of the present invention, there is provided a device for assessing a learning ability, the device including a transceiver configured to communicate with a user terminal and a controller configured to acquire a user's assessment data through the transceiver and assess a learning ability on the basis of the assessment data. The controller acquires target assessment data of a target user and a reference user related to a target domain, wherein the target assessment data includes question data related to the target domain and answer data of the target user and the reference user for the question data, acquires a target neural network model of which training has been completed, acquires comparison information representing the target user's ability in relation to the reference user's ability in the target domain through the target neural network model, and calculates the target user's virtual score in the target domain on the basis of the comparison information.

Solutions to the objects of the present invention are not limited to those described above, and other solutions which have not been described above will be clearly understood by those of ordinary skill in the art from the specification and accompanying drawings.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram schematically illustrating a learning ability assessment system according to an exemplary embodiment of the present invention;

FIG. 2 is a diagram illustrating operations of the learning ability assessment system according to the exemplary embodiment of the present invention;

FIG. 3 is a diagram illustrating operations of a training device according to an exemplary embodiment of the present invention;

FIG. 4 is a flowchart illustrating a method of acquiring a target neural network model according to an exemplary embodiment of the present invention;

FIG. 5 is a detailed flowchart illustrating a method of training a reference neural network model according to an exemplary embodiment of the present invention;

FIG. 6 is a diagram illustrating an aspect of training a reference neural network model according to an exemplary embodiment of the present invention;

FIG. 7 is a flowchart illustrating a learning ability assessment method according to an exemplary embodiment of the present invention; and

FIG. 8 is a diagram illustrating an aspect of acquiring a target user's comparison information through a target neural network according to an exemplary embodiment of the present invention.

### DETAILED DESCRIPTION OF EXEMPLARY EMBODIMENTS

The above-described objects, features, and advantages of the present invention will be apparent through the following detailed description related to the accompanying drawings. Since the present invention can be modified in various ways and have various embodiments, specific embodiments will be illustrated in the drawings and described in detail below.

Throughout the specification, like reference numerals basically refer to like elements. Elements having the same function within the scope of the same idea shown in the drawings of each embodiment will be described using the same reference numerals, and overlapping descriptions thereof will be omitted.

When it is determined that a detailed description of a known function or element related to the present invention may unnecessarily obscure the subject matter of the present invention, the detailed description will be omitted. Also, numerals (e.g., first and second) used in the description of the specification are merely identifiers for distinguishing one element from another.

The suffixes “module” and “unit” for elements used in the following embodiments are given or interchangeably used in consideration of only the ease of drafting the specification and do not have a meaning or role distinct from each other.

In the following embodiments, the singular forms are intended to include the plural forms as well unless the context clearly indicates otherwise.

The terms “comprises,” “comprising,” “includes,” “including,” “has,” “having,” etc. mean the presence of features or elements stated herein and do not preclude the possibility of adding one or more other features or elements.

In the drawings, the sizes of elements may be exaggerated or reduced for the convenience of description. For example, the size and thickness of each element shown in the drawings are arbitrarily shown for the convenience of description, and thus the present invention is not necessarily limited to those shown in the drawings.

When a certain embodiment can be implemented differently, a specific process may be performed in a different order than that described. For example, two processes described in succession may be performed substantially simultaneously or performed in a reverse order of that described.

In the following embodiments, when elements and the like are referred to as being connected, the elements may be directly connected or indirectly connected with elements interposed therebetween.

For example, when elements and the like are referred to as being electrically connected herein, the elements and the like may be directly and electrically connected or may be indirectly and electrically connected with an element and the like interposed therebetween.

A method of training a learning ability assessment method according to an exemplary embodiment of the present invention may include an operation of acquiring target assessment data of a target user and a reference user related to a target domain, wherein the target assessment data includes question data related to the target domain and answer data of the target user and the reference user for the question data, an operation of acquiring a target neural network model of which training has been completed, an operation of acquiring comparison information representing the target user's ability in relation to the reference user's ability in the target domain through the target neural network model, and an operation of calculating the target user's virtual score in the target domain on the basis of the comparison information.

According to the exemplary embodiment of the present invention, the target neural network model may include an input layer for receiving the target assessment data, an output layer for outputting the comparison information representing the target user's ability in relation to the reference user's ability in the target domain, and a hidden layer having a plurality of nodes connecting the input layer and the output layer.

According to the exemplary embodiment of the present invention, the target neural network model may be acquired by transferring a reference neural network model which has been trained to output label information representing an ability ratio of users on the basis of a reference assessment database related to a reference domain different from the target domain, and the reference neural network model may have been trained by adjusting weights of the plurality of nodes so that the label information may be output on the basis of the reference assessment database.

According to the exemplary embodiment of the present invention, the operation of acquiring the target neural network model may include an operation of acquiring a reference assessment database related to a reference domain different from the target domain, wherein the reference assessment database includes reference question data related to the reference domain, answer data of each of two or more users for the reference question data, and score data of each of the two or more users in the reference domain, an operation of extracting a feature, which is a base for calculating the two or more user's relative abilities, from the reference assessment database, an operation of training a reference neural network model on the basis of the extracted feature, and an operation of transferring the reference neural network model of which training has been completed to the target domain.

According to the exemplary embodiment of the present invention, the operation of training the reference neural network model may include an operation of acquiring a training set including label information related to a relative ability ratio of the two or more users from the reference assessment database and an operation of inputting the feature to an input layer of the reference neural network model and training the reference neural network model by adjusting weights of nodes of the reference neural network model on the basis of a difference between an output value output through an output layer of the reference neural network model and the label information.

An exemplary embodiment of the present invention may provide a computer-readable recording medium on which a program for performing the learning ability assessment method is recorded.

A learning ability assessment device according to an exemplary embodiment of the present invention may include a transceiver configured to communicate with a user terminal and a controller configured to acquire a user's assessment data through the transceiver and assess a learning ability on the basis of the assessment data. The controller may acquire target assessment data of a target user and a reference user related to a target domain, wherein the target assessment data includes question data related to the target domain and answer data of the target user and the reference user for the question data, acquire a target neural network model of which training has been completed, acquire comparison information representing the target user's ability in relation to the reference user's ability in the target domain through the target neural network model, and calculate the target user's virtual score in the target domain on the basis of the comparison information.

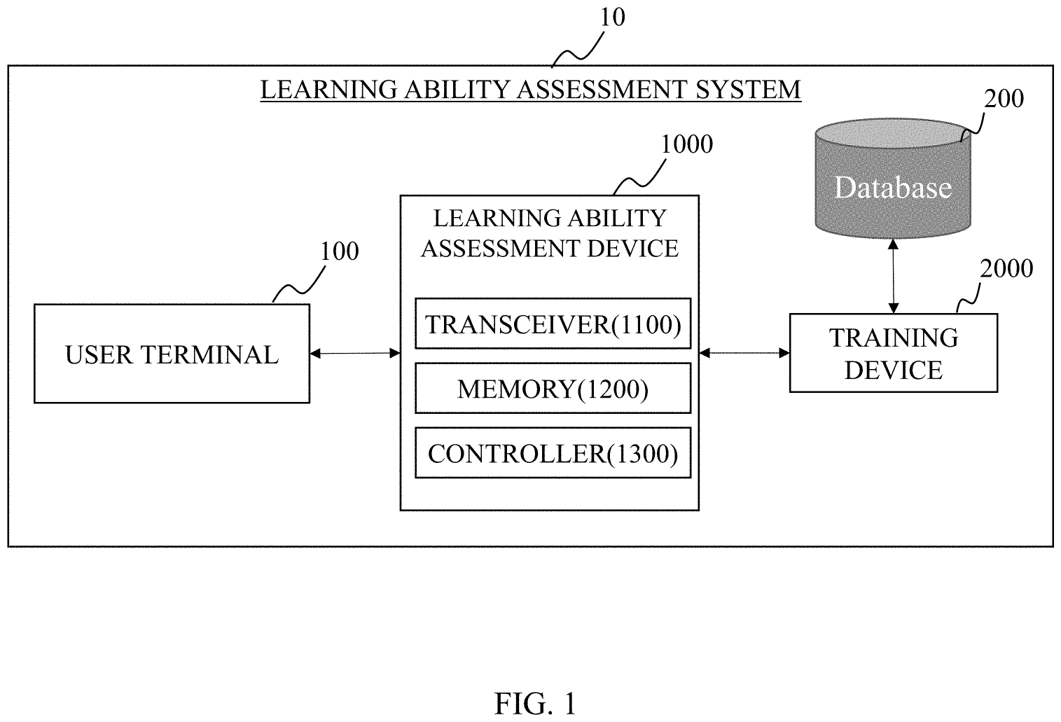

Hereinafter, a learning ability assessment method, device, and system according to exemplary embodiments of the present invention will be described with reference to FIGS. 1 to 8.

FIG. 1 is a block diagram schematically illustrating a learning ability assessment system 10 according to an exemplary embodiment of the present invention.

The learning ability assessment system 10 according to the exemplary embodiment of the present invention may include a user terminal 100, a database 200, a learning ability assessment device 1000, and a training device 2000.

The user terminal 100 may acquire a question database from the learning ability assessment device 1000 or an arbitrary external device. For example, the user terminal 100 may receive some questions included in the question database and display the received questions to a user. Subsequently, the user (or learner) may input answers for the displayed questions to the user terminal 100.

The user terminal 100 may acquire assessment data on the basis of the user's answers and transmit the assessment data of the user to the learning ability assessment device 1000. The assessment data may encompass information on the questions answered by the user, the user's answer information for the questions, correct and incorrect answer information for the questions, etc. Meanwhile, the user terminal 100 may transmit identification information of the user to the learning ability assessment device 1000.

Meanwhile, the user terminal 100 may receive score information calculated by the learning ability assessment device 1000 and/or user-customized educational content acquired on the basis of the score information. Also, the user terminal 100 may display the score information and/or educational content to the user. The educational content may be any education-related content such as an education-related webpage, a solution to a question, and a recommendation question.

The database 200 according to the exemplary embodiment of the present invention may store various pieces of data of the learning ability assessment system 10.

As an example, the database 200 may store various pieces of data related to a reference domain. For example, the database 200 may include any data including question information related to the reference domain, users' answer information for questions, the users' score information in the reference domain, etc.

As another example, the database 200 may store various pieces of data related to the training device 2000. For example, the database 200 may include any data of a neural network model trained by the training device 2000, and the data may include weights (or parameter information) of nodes of the trained neural network model and/or execution data of the trained neural network model.

However, the above description is merely exemplary, and the database 200 may store any data related to a target domain. For example, the database 200 may store question information related to the target domain and/or users' answer information for questions.

Meanwhile, the reference domain may be any educational domain in which a user's score information calculated on the basis of the user's assessment data is present. On the other hand, the target domain may be any educational domain in which a user's score information is not present or is insufficient.

The learning ability assessment device 1000 according to the exemplary embodiment of the present invention may perform an operation of quantifying the user's learning ability in the target domain in which the user's score information is not present using a neural network model trained on the basis of an assessment database related to the reference domain.

The learning ability assessment device 1000 according to the exemplary embodiment of the present invention may include a transceiver 1100, a memory 1200, and a controller 1300.

The transceiver 1100 may communicate with any external device including the user terminal 100. For example, the learning ability assessment device 1000 may receive various pieces of data including the user's assessment data and/or user identification information from the user terminal 100 through the transceiver 1100 or transmit various pieces of data including the user's score information and/or educational content to the user terminal 100.

The learning ability assessment device 1000 may access a network through the transceiver 1100 to transmit and receive various pieces of data. The transceiver 1100 may be a wired type or a wireless type. Since each of the wired type and the wireless type has advantages and disadvantages, both the wired type and the wireless type may be provided in the learning ability assessment device 1000 in some cases. The wireless type may employ a wireless local area network (WLAN)-based communication method such as Wi-Fi. Alternatively, the wireless type may employ cellular communication, for example, a Long Term Evolution (LTE) or fifth generation (5G) communication method. However, a wireless communication protocol is not limited to the above-described examples, and any appropriate wireless communication method may be used. For example, the wired type representatively employs LAN or universal serial bus (USB) communication and may also employ other communication methods.

The memory 1200 may store various pieces of information. In the memory 1200, various pieces of data may be temporarily or semi-permanently stored. Examples of the memory 1200 include a hard disk driver (HDD), a solid state drive (SSD), a flash memory, a read-only memory (ROM), a random access memory (RAM), etc. The memory 1200 may be provided in a form that is embedded in or detachable from the learning ability assessment device 1000. The memory 1200 may store an operating system (OS) for running the learning ability assessment device 1000, a program for operating each element of the learning ability assessment device 1000, and various pieces of data required for operations of the learning ability assessment device 1000.

The controller 1300 may control the overall operation of the learning ability assessment device 1000. For example, the controller 1300 may control an operation of acquiring a user's target assessment data to be described below, an operation of acquiring comparison information using the target assessment data and a target neural network model, an operation of calculating the user's virtual score on the basis of the comparison information, etc. Specifically, the controller 1300 may load a program for the overall operation of the learning ability assessment device 1000 from the memory 1200 and run the program. The controller 1300 may be implemented as an application processor (AP), a central processing unit (CPU), or a similar device on the basis of hardware, software, or a combination of hardware and software. As hardware, the controller 1300 may be provided in the form of an electronic circuit for processing an electrical signal to perform a control function. As software, the controller 1300 may be provided in the form of a program or code for operating a hardware circuit.

The training device 2000 according to the exemplary embodiment of the present invention may perform an operation of training a model for quantifying a user's learning ability. For example, the training device 2000 may perform an operation of training a model for quantifying a target user's learning ability related to the target domain on the basis of the assessment database related to the reference domain.

For example, the training device 2000 may use a neural network model as a model for assessing a user's learning ability. The neural network model may be provided as a machine learning model. A representative example of the machine learning model may be an artificial neural network. Specifically, a representative example of the artificial neural network may be a deep learning-based artificial neural network including an input layer for receiving data, an output layer for outputting a result, and a hidden layer for processing data between the input layer and the output layer. Detailed examples of the artificial neural network include a convolutional neural network, a recurrent neural network, a deep neural network, a generative adversarial network, etc. In the present specification, an artificial neural network is interpreted as a comprehensive meaning that encompasses all of the above-described artificial neural networks, various other forms of artificial neural networks, and artificial neural networks having a combined form of the artificial neural networks, and an artificial neural network is not necessarily based on deep learning.

Further, the machine learning model does not necessarily have the form of an artificial neural network model. In addition to an artificial neural network model, the machine learning model may employ a K-nearest neighbors (KNN) algorithm, a random forest, a support vector machine (SVM), principal component analysis (PCA), etc. Alternatively, the machine learning model may be an ensemble of the above-described techniques or may have various combined forms of the above-described techniques. Meanwhile, in exemplary embodiments described on the basis of an artificial neural network, the artificial neural network may be replaced with another machine learning model unless specifically described otherwise.

Moreover, an algorithm for quantifying a target user's learning ability is not necessarily limited to a machine learning model. In other words, an algorithm for quantifying a target user's learning ability may include various judgement/decision algorithms other than a machine learning model. Accordingly, in the specification, an algorithm for quantifying a target user's learning ability is to be understood as a comprehensive meaning which encompasses any forms of algorithms for calculating target score information using a target user's target assessment data. However, for the convenience of description, an artificial neural network model will be mainly described.

The training device 2000 according to the exemplary embodiment of the present invention may include a transceiver, a memory, and a controller. In this regard, the above description of the transceiver 1100, the memory 1200, and the controller 1300 of the learning ability assessment device 1000 may apply, and thus the description thereof will be omitted.

Meanwhile, FIG. 1 shows that the learning ability assessment device 1000 and the training device 2000 are separately configured. However, this is merely exemplary, and the learning ability assessment device 1000 and the training device 2000 may be integrated with each other.

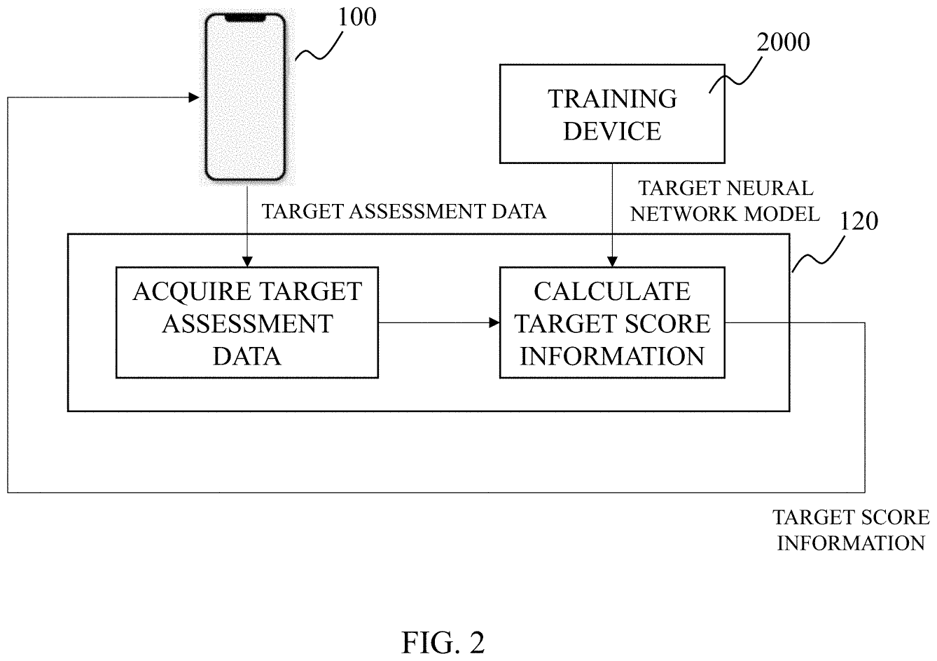

Operations of the learning ability assessment device 1000 and/or the training device 2000 included in the learning ability assessment system 10 according to exemplary embodiments of the present invention will be described in detail below with reference to FIGS. 2 to 8.

According to the related art, research has been performed on technologies for assessing a learner's ability using the learner's answer to a question and the like. For example, according to the related art, a neural network model is trained with learners' learning data and the learners' actual score information such that a leaner's ability is quantified. However, training a neural network model requires a considerable amount of learning data of learners and the learners' actual score information. Accordingly, the related art has a problem in that it takes a considerable amount of cost and time to collect a training set for training a neural network model. Also, the related art has a limitation in that learners' actual score information in a target domain is essentially required for training a neural network model.

The learning ability assessment device 1000 according to the exemplary embodiment of the present invention can acquire a neural network model for quantifying a learner's ability in a target domain in which training sets (e.g., score information in the target domain) are not enough. Specifically, the learning ability assessment device 1000 according to the exemplary embodiment of the present invention can quantify or assess a learner's ability in a target domain, in which data is not enough, by using a technique for transferring a reference neural network model trained with training sets related to a reference domain to a target neural network model related to a target domain.

Operations of the learning ability assessment device 1000 of the learning ability assessment system 10 for achieving the above-described objects and effects according to the exemplary embodiment of the present invention will be described in detail below with reference to FIG. 2. FIG. 2 is a diagram illustrating operations of the learning ability assessment system according to the exemplary embodiment of the present invention.

The learning ability assessment device 1000 of the learning ability assessment system 10 according to the exemplary embodiment of the present invention may acquire target assessment data from the user terminal 100. The target assessment data may be assessment data related to a target domain. For example, the target assessment data may include question data related to the target domain and answer data of each of a target user and a reference user for the question data. Alternatively, the target assessment data may include correct or incorrect answer data of each of the target user and the reference user for question data related to the target domain. As described above, the target domain may be any educational domain in which a user's score information is not present or is insufficient.

The learning ability assessment device 1000 according to the exemplary embodiment of the present invention may acquire a target neural network model of which training has been completed. For example, the learning ability assessment device 1000 may acquire any data, which includes execution data related to the trained target neural network model, weight data of nodes, etc., for executing the target neural network model from the training device 2000.

The learning ability assessment device 1000 according to the exemplary embodiment of the present invention may calculate the target user's target score information in the target domain using the target neural network model. For example, the learning ability assessment device 1000 may acquire comparison information representing a ratio of the target user's ability to the reference user's ability on the basis of the target assessment data using the target neural network model. Also, the learning ability assessment device 1000 may perform an operation of calculating the target user's virtual score in the target domain on the basis of the comparison information.

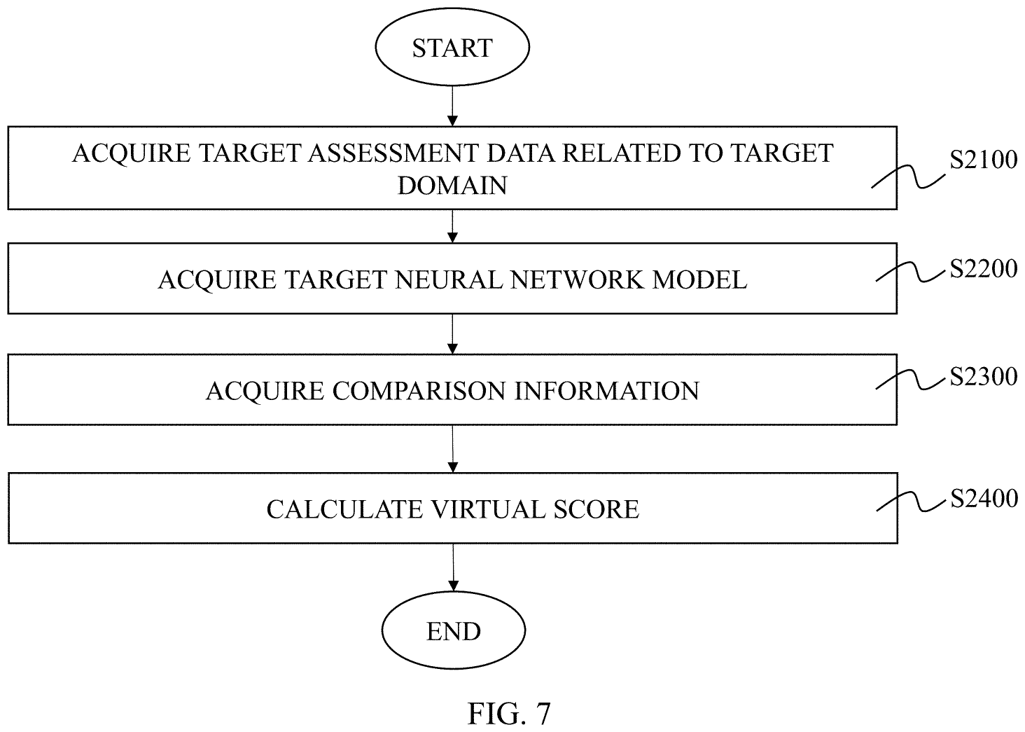

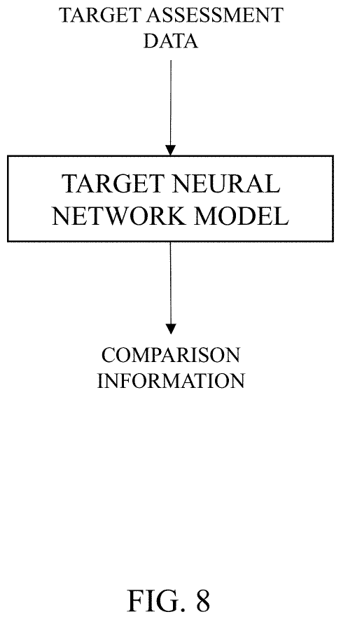

Operations of the learning ability assessment device 1000 according to the exemplary embodiment of the present invention will be described in more detail with reference to FIGS. 7 and 8.

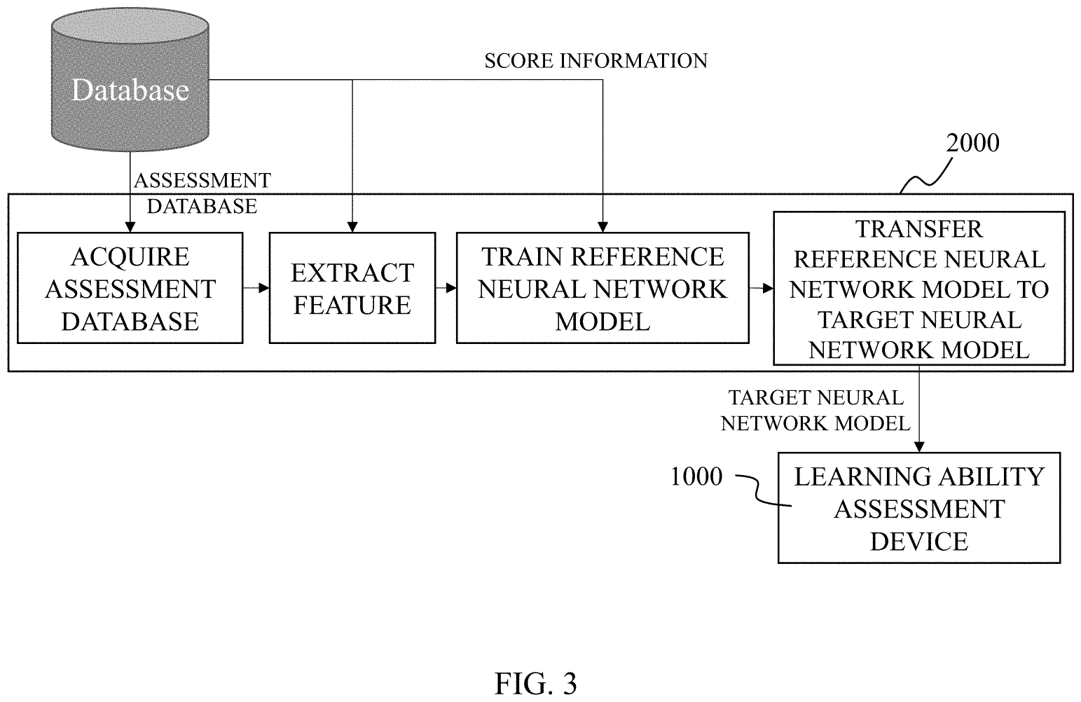

Operations of the training device 2000 for acquiring a target neural network model according to the exemplary embodiment of the present invention will be described in detail below with reference to FIG. 3. FIG. 3 is a diagram illustrating operations of the training device 2000 according to the exemplary embodiment of the present invention.

The training device 2000 according to the exemplary embodiment of the present invention may acquire an assessment database from the database 200. The database (hereinafter “reference assessment database”) may include question data related to a reference domain, answer data of each of at least two users for the question data, and/or score data of each of the at least two users in the reference domain. Alternatively, the reference assessment database may include correct and incorrect answer data of the two or more users for the question data related to the reference domain. As described above, the reference domain is any educational domain in which a user's score information calculated on the basis of the user's assessment data is present.

The training device 2000 according to the exemplary embodiment of the present invention may perform an operation of extracting a feature for learning a relative ability ratio of users from the reference assessment database.

As an example, the training device 2000 may extract a feature related to relative abilities of users from the reference assessment database. For example, the training device 2000 may extract a feature from the reference assessment database by comparing a first user's answer data for question data with a second user's answer data for the question data and/or the second user's score data in the reference domain. For example, the training device 2000 may extract a feature from the reference assessment database by comparing the first user's score data in the reference domain with the second user's answer data for the question data and/or the second user's score data in the reference domain.

As another example, the training device 2000 may extract each individual feature of a user from the reference assessment database. The extracted each individual feature of the user may be used in training a model for calculating a relative ability difference between users. For example, from the reference assessment database, the training device 2000 may extract any feature including each user's average answer speed, a correct answer rate for a question set answered by each user, an ability indicator (e.g., an ability indicator predicted by any model, such as an Elo model and an item response theory (IRT) model, for representing an ability) predicted on the basis of each user's assessment data, each user's learning score, etc.

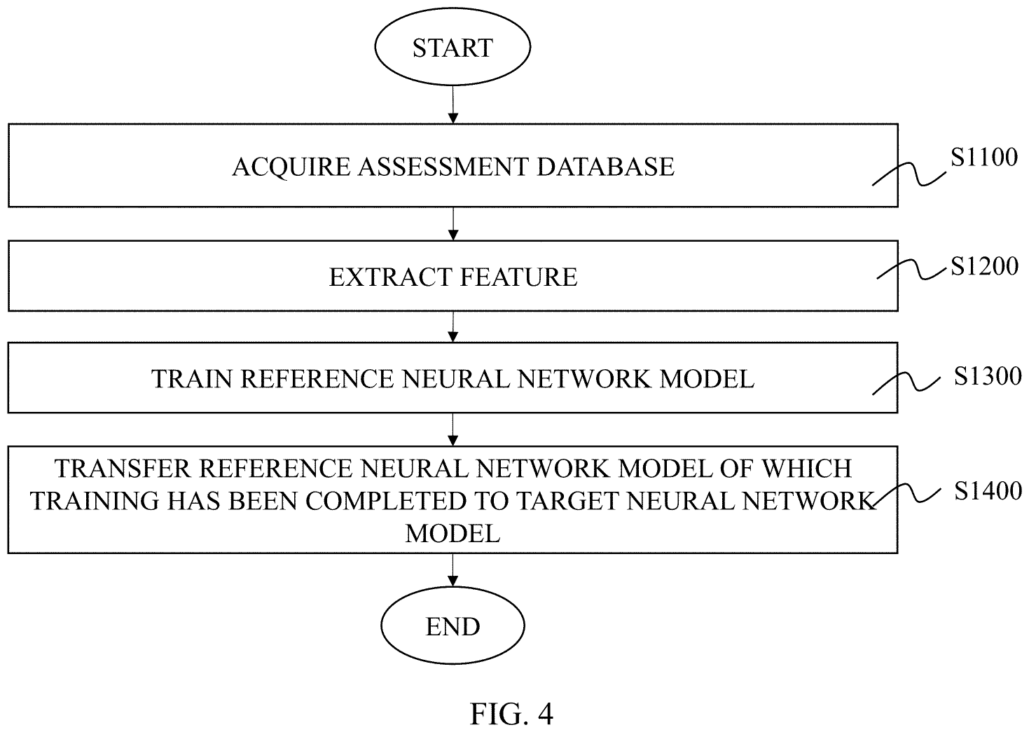

The training device 2000 according to the exemplary embodiment of the present invention may train a reference neural network model. Specifically, the training device 2000 may acquire a training set including label information related to a relative ability ratio of users in the reference domain from the reference assessment database. Also, the training device 2000 may train the reference neural network model on the basis of the feature and the label information. Training the reference neural network model will be described in more detail with reference to FIGS. 4 to 6.

The training device 2000 according to the exemplary embodiment of the present invention may perform an operation of transferring the reference neural network model of which training has been completed to a target domain. For example, the training device 2000 may transfer the reference neural network model to a target neural network model which is usable in the target domain using a transfer learning technique. Also, the training device 2000 according to the exemplary embodiment of the present invention may transmit the target neural network model or any data for executing the target neural network model to the learning ability assessment device 1000.

It has been illustrated in FIG. 3 that the training device 2000 performs all the above-described operations. However, this is merely exemplary, and at least some of the operations of the training device 2000 may be performed by any external device including the learning ability assessment device 1000 and an external server.

A method of acquiring a target neural network model according to an exemplary embodiment of the present invention will be described in detail below with reference to FIG. 4. FIG. 4 is a flowchart illustrating a method of acquiring a target neural network model according to an exemplary embodiment of the present invention.

The method of acquiring a target neural network model according to the exemplary embodiment of the present invention may include an operation S1100 of acquiring an assessment database, an operation S1200 of extracting a feature, an operation S1300 of training a reference neural network model, and an operation S1400 of transferring the reference neural network model of which training has been completed to a target neural network model.

In the operation S1100 of acquiring the assessment database, the training device 2000 according to the exemplary embodiment of the present invention may acquire a reference assessment database. The reference assessment database may include any data related to a reference domain. For example, the reference assessment database may include question data related to the reference domain, answer data of users for the question data, and/or score data of each of the users in the reference domain. Alternatively, the reference assessment database may include correct and incorrect answer data of the users for the question data related to the reference domain. As described above, the reference domain is any educational domain in which a user's score information calculated on the basis of the user's assessment data is present.

In the operation S1200 of extracting the feature, the training device 2000 according to the exemplary embodiment of the present invention may extract a feature, which is a base for training a neural network for calculating a relative ability ratio of users, from the reference assessment database.

As an example, the training device 2000 may extract a feature related to relative abilities of users from the reference assessment database. For example, the training device 2000 may extract a feature representing relative answers of a first user and a second user by comparing the first user's answer data for a question set related to the reference domain with the second user's answer data for the question set. Specifically, the training device 2000 may extract a feature related to the relative answers of the first user and the second user by comparing score information of the first user and the second user based on relative answers of the first user and the second user to the question set related to the reference domain.

As another example, the training device 2000 may extract each individual feature of a user from the reference assessment database. The extracted each individual feature of the user may be used in training a model for calculating a relative ability difference between users or a relative ability ratio of users. For example, from the reference assessment database, the training device 2000 may extract any feature including each user's average answer speed for questions, a correct answer rate for a question set answered by each user, any form of ability indicator (e.g., a user's ability indicator predicted by any model, such as an Elo model and an IRT model, for representing an ability) predicted on the basis of the user's assessment data, the user's existing score information, etc.

In the operation S1300 of training the reference neural network model, the training device 2000 according to the exemplary embodiment of the present invention may train a reference neural network model on the basis of the feature. Specifically, the training device 2000 may acquire a training set including label information related to a relative ability ratio of two or more users from the reference assessment database. The training device 2000 may be implemented to train the reference neural network model using the feature and the label information.

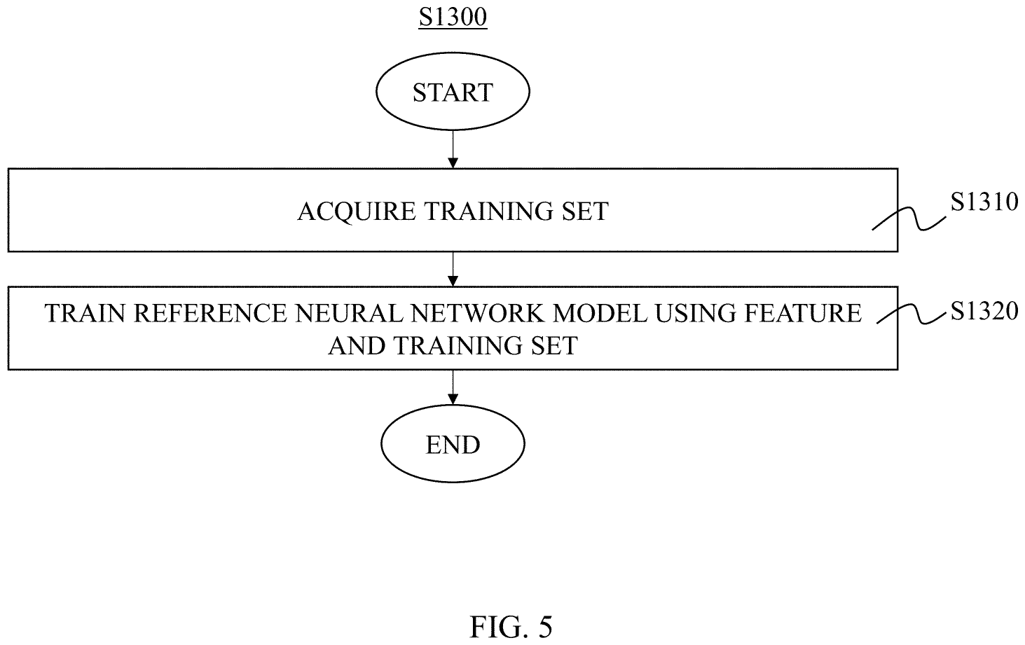

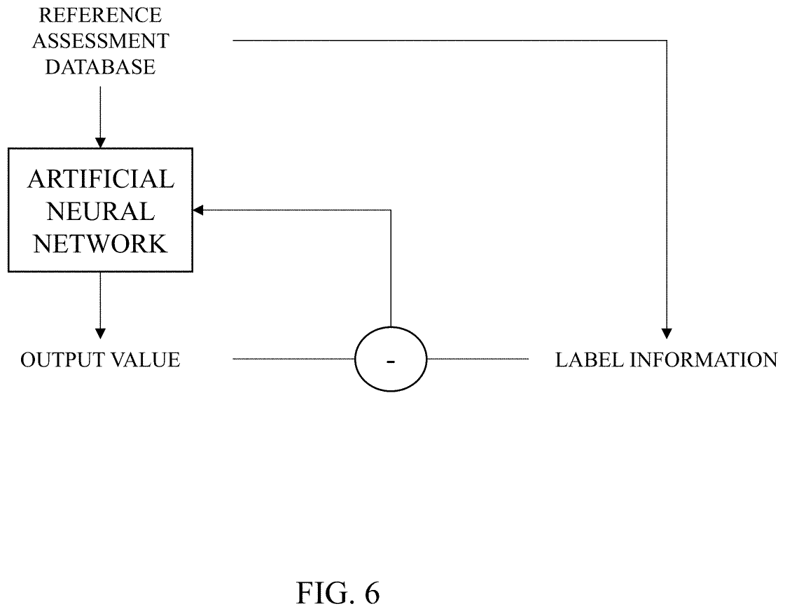

See FIGS. 5 and 6. FIG. 5 is a detailed flowchart illustrating a method of training a reference neural network model according to an exemplary embodiment of the present invention. FIG. 6 is a diagram illustrating an aspect of training a reference neural network model according to an exemplary embodiment of the present invention.

The operation S1300 of training the reference neural network model may include an operation S1310 of acquiring a training set and an operation S1320 of training the reference neural network model using the feature and the training set.

In the operation S1310 of acquiring the training set, the training device 2000 according to the exemplary embodiment of the present invention may acquire a training set including label information related to a relative ability ratio of two or more users from the reference assessment database. For example, the training device 2000 may acquire a training set including label information representing a relative ability ratio of a user on the basis of users' score information, which is included in the reference assessment database, in the reference domain. Specifically, the training set may include label information s1/(s1+s2) related to a relative ability ratio of a first user to a second user which is prepared on the basis of score information related to a first score value s1 of the first user in the reference domain and score information related to a second score value s2 of the second user in the reference domain.

In the operation S1320 of training the reference neural network model using the feature and the training set, the training device 2000 according to the exemplary embodiment of the present invention may train the reference neural network model on the basis of users' answer data for a question set in the reference domain and the users' score data which are included in the reference assessment database.

As an example, the training device 2000 may train the reference neural network model using the feature and the training set. For example, the reference neural network model may include an input layer, an output layer, and a plurality of nodes connecting the input layer and the output layer. In this case, the training device 2000 may input the feature extracted as described above to the input layer and train the reference neural network model by adjusting a weight (or a parameter) of at least one node of the reference neural network model on the basis of a difference between an output value output through the output layer and label information related to relative abilities of users in the reference domain.

Also, the training device 2000 may repeatedly perform the above-described training process to acquire the reference neural network model which is trained to output an output value approximate to the label information through the output layer.

Referring back to FIG. 4, the method of acquiring a target neural network model according to the exemplary embodiment of the present invention may include the operation S1400 of transferring the reference neural network model of which training has been completed to the target neural network model.

In the operation S1400 of transferring the reference neural network model of which training has been completed to the target neural network model, the training device 2000 according to the exemplary embodiment of the present invention may perform an operation of transferring the reference neural network model of which training has been completed to the target domain. In this case, the training device 2000 may acquire a target neural network model which is usable in the target domain by transferring the reference neural network model of which training has been completed using a transfer learning technique. Transfer learning is a learning technique for transferring a neural network model built in a specific domain to a similar domain. With transfer learning, it is possible to build a model having performance available in a domain to which knowledge will be transferred even when there is little or no data in the domain.

Meanwhile, although not shown in FIG. 4, the training device 2000 according to the exemplary embodiment of the present invention may be implemented to transmit the target neural network model. For example, the training device 2000 may be implemented to transmit any data, which includes parameters (or weights) of a plurality of nodes of the target neural network model, for executing the target neural network model to the learning ability assessment device 1000.

A method of assessing a user's learning ability using a target neural network model according to an exemplary embodiment of the present invention will be described in detail below with reference to FIGS. 7 and 8. FIG. 7 is a flowchart illustrating a learning ability assessment method according to an exemplary embodiment of the present invention. FIG. 8 is a diagram illustrating an aspect of acquiring a target user's comparison information through a target neural network according to an exemplary embodiment of the present invention.

The learning ability assessment method according to the exemplary embodiment of the present invention may include an operation S2100 of acquiring target assessment data related to a target domain, an operation S2200 of acquiring a target neural network model, an operation S2300 of acquiring comparison information through the target neural network model, and an operation S2400 of calculating a virtual score.

In the operation S2100 of acquiring the target assessment data related to the target domain, the learning ability assessment device 1000 according to the exemplary embodiment may acquire target assessment data related to a target domain from the user terminal 100. The target assessment data may include question data related to the target domain, a user's answer data for the question data, and/or the user's correct and incorrect answer data for questions. For example, the learning ability assessment device 1000 may acquire target assessment data of a target user who wants to assess his or her ability. Also, the learning ability assessment device 1000 may acquire target assessment data of at least one reference user which will be a base for calculating comparison data to be described below.

In the operation S2200 of acquiring the target neural network, the learning ability assessment device 1000 according to the exemplary embodiment of the present invention may acquire a target neural network model. Specifically, the learning ability assessment device 1000 may acquire any data, which includes execution data of the target neural network model and/or weight (or parameter) data of a plurality of nodes, required for executing the target neural network model.

In the operation S2300 of acquiring the comparison information through the target neural network model, the learning ability assessment device 1000 according to the exemplary embodiment of the present invention may acquire comparison information representing the user's relative ability in the target domain using the target neural network model. Specifically, the learning ability assessment device 1000 may input the target assessment data to an input layer of the target neural network and acquire comparison information which is output through an output layer and represents the target user's ability in relation to a reference user's ability in the target domain.

As an example, the comparison information may be information obtained by estimating and quantifying a ratio of the target user's ability to at least one reference user's ability in the target domain. For example, when the target user answers a question set related to the target domain with a first combination and the reference user answers the question set with a second combination, the learning ability assessment device 1000 may acquire comparison information representing the target user's ability in relation to the reference user's ability through the target neural network model on the basis of a similarity and/or difference between the target user's answer data (or correct and incorrect answer data) and the reference user's answer data (or correct and incorrect answer data).

Since the target neural network model has been trained to output label information representing a relative ability ratio of users on the basis of the users' answer data to a question in the reference domain, correct and incorrect answer data, and/or score information in the reference domain, it is possible to output comparison information representing relative abilities of users on the basis of the users' answer data (or correct and incorrect answer data) to a question in the target domain in which score information is not enough.

However, the above-described comparison information is merely exemplary, and the neural network model may be configured to acquire any form of information representing relative abilities of users. Also, the forms of training sets and label information may be appropriately changed to acquire any form of information representing relative abilities of users.

In the operation S2400 of calculating the virtual score, the learning ability assessment device 1000 according to the exemplary embodiment of the present invention may be implemented to calculate the target user's virtual score in the target domain on the basis of the comparison information. For example, the learning ability assessment device 1000 may calculate the target user's virtual score by decoding the comparison information representing the target user's ability in relation to the reference user's ability through the target neural network model.

Meanwhile, although not shown in FIG. 7, the learning ability assessment method according to the exemplary embodiment of the present invention may further include an operation of transmitting the virtual score information. In the operation of transmitting the virtual score information, the learning ability assessment device 1000 may transmit the virtual score information to the user terminal 100 through the transceiver 1100. Also, the user terminal 100 receiving the virtual score information may output the virtual score information to the user through any output part (e.g., a display, a speaker, or a monitor).

The learning ability assessment device 1000 according to the exemplary embodiment of the present invention may generate a model that may logically give a score to a learner without collecting the learner's score information in a new domain in which data is not enough. Accordingly, the learning ability assessment device 1000 according to the exemplary embodiment of the present invention can provide a beneficial effect of saving time and cost required to collect actual score information in the target domain. Also, the learning ability assessment system 10 according to the exemplary embodiment of the present invention can precisely predict a learner's ability using a technique for transferring a neural network model, which has been precisely trained with assessment data in a reference domain in which assessment data is enough, to a target domain.

The above-described various operations of the learning ability assessment device 1000 may be stored in the memory 1200 of the learning ability assessment device 1000, and the controller 1300 of the learning ability assessment device 1000 may perform the operations stored in the memory 1200. Also, the above-described various operations of the training device 2000 may be stored in a memory of the training device 2000, and a controller of the training device 2000 may perform the operations stored in the memory.

With the method, device, and system for assessing a learning ability according to the exemplary embodiments of the present invention, it is possible to minimize a collection of a learner's score information and give a logical score to the learner.

With the method, device, and system for assessing a learning ability according to the exemplary embodiments of the present invention, it is possible to save time and cost required to collect a learner's assessment data.

Effects of the present invention are not limited to those described above, and other effects which have not been described above will be clearly understood by those of ordinary skill in the art from the specification and accompanying drawings.

The features, structures, effects, etc. described in the exemplary embodiments are included in at least one embodiment of the present invention and are not necessarily limited to one embodiment. Further, the features, structures, effects, etc. illustrated in each embodiment can be combined or modified in other embodiments by those of ordinary skill in the art to which the embodiments belong. Accordingly, contents related to the combination and modification should be construed to be included in the scope of the present invention.

Although embodiments of the present invention have been described above, these are just examples and do not limit the present invention. The present invention can be modified and applied in various ways not illustrated above without departing from the essential features of the present invention by those of ordinary skill in the art. In other words, each element described in detail in the embodiments can be modified. Also, differences related to the modification and application should be construed as falling within the scope of the present invention, which is defined by the accompanying claims.

What is claimed is:

1. A method of assessing a learning ability of a user by a learning ability assessment device for assessing a learning ability of a user according to an answer of the user to a question, the method comprising:
acquiring target assessment data of a target user and a reference user related to a target domain, wherein the target assessment data includes question data related to the target domain and answer data of the target user and the reference user for the question data;
acquiring a target neural network model of which training has been completed;
acquiring comparison information representing an ability of the target user in relation to an ability of the reference user in the target domain through the target neural network model; and
calculating a virtual score of the target user in the target domain on the basis of the comparison information.

2. The method of claim 1, wherein the target neural network model comprises:
an input layer configured to receive the target assessment data;
an output layer configured to output the comparison information representing the ability of the target user in relation to the ability of the reference user in the target domain; and
a hidden layer having a plurality of nodes connecting the input layer and the output layer.

3. The method of claim 2, wherein the target neural network model is acquired by transferring a reference neural network model which has been trained to output label information representing an ability ratio of users on the basis of a reference assessment database related to a reference domain different from the target domain, and
the reference neural network model has been trained by adjusting weights of the plurality of nodes so that the label information is output on the basis of the reference assessment database.

4. The method of claim 1, wherein the acquiring of the target neural network model comprises:
acquiring a reference assessment database related to a reference domain different from the target domain, wherein the reference assessment database includes reference question data related to the reference domain, answer data of each of two or more users for the reference question data, and score data of each of the two or more users in the reference domain;
extracting a feature, which is a base for calculating relative abilities of the two or more users, from the reference assessment database;
training a reference neural network model on the basis of the extracted feature; and
transferring the reference neural network model of which training has been completed to the target domain.

5. The method of claim 4, wherein the training of the reference neural network model comprises:
acquiring a training set including label information related to a relative ability ratio of the two or more users from the reference assessment database; and
inputting the feature to an input layer of the reference neural network model and adjusting weights of nodes of the reference neural network model on the basis of a difference between an output value output through an output layer of the reference neural network model and the label information to train the reference neural network model.

6. A non-transitory computer-readable recording medium in which a computer program executed by a computer is recorded, the computer program comprising:
acquiring target assessment data of a target user and a reference user related to a target domain, wherein the target assessment data includes question data related to the target domain and answer data of the target user and the reference user for the question data;
acquiring a target neural network model of which training has been completed;
acquiring comparison information representing an ability of the target user in relation to an ability of the reference user in the target domain through the target neural network model; and
calculating a virtual score of the target user in the target domain on the basis of the comparison information.

7. A device for assessing a learning ability of a user by receiving an answer of the user to a question, the device comprising:
a transceiver configured to communicate with a user terminal; and
a controller configured to acquire assessment data of a user through the transceiver and assess a learning ability on the basis of the assessment data,
wherein the controller acquires target assessment data of a target user and a reference user related to a target domain, wherein the target assessment data includes question data related to the target domain and answer data of each of the target user and the reference user for the question data, acquires a target neural network model of which training has been completed, acquires comparison information representing an ability of the target user in relation to an ability of the reference user in the target domain through the target neural network model, and calculates a virtual score of the target user in the target domain on the basis of the comparison information.
